(19) United States
(12) Patent Application Publication
(10) Pub. No.: US 2018/0191935 A1
(43) Pub. Date: Jul. 5, 2018

(54) IMAGE SENSING METHOD AND IMAGE SENSOR WITH ROLLING EXPOSURE TIME COMPENSATION

(71) Applicant: EOSMEM Corporation, Zhubei City (TW)

(72) Inventors: Chu-Hsin Chang, Zhubei City (TW); Cheng-En Hsieh, Zhubei City (TW); Kai-Ting Ho, Chupei (TW); Ching-Lung Ti, Chupei (TW); Yi-Chin Tsou, Chupei (TW); Hui-Min Tsai, Taipei (TW); Ju-Yu Yu, Chupei (TW)

(21) Appl. No.: 15/858,572

(22) Filed: Dec. 29, 2017

Related U.S. Application Data
(60) Provisional application No. 62/440,746, filed on Dec. 30, 2016.

(30) Foreign Application Priority Data
Aug. 30, 2017 (TW) 106129510

(51) Int. Cl. H04N 5/235; H04N 5/353

(52) U.S. Cl. CPC H04N 5/2353; H04N 5/3532

(57) ABSTRACT

An image sensing method includes: emitting light to a object to generate an image; providing a sensing device, which has plural sensor units arranged by plural columns and plural rows; receiving the image by the sensing device by way of rolling exposure; controlling a rolling shutter, such that when the sensing device receives the image by way of rolling exposure, the exposure time of at least one sensor row is adaptively determined.

### CROSS REFERENCE

The present invention claims priority to U.S. Ser. No. 62/440746, filed on Dec. 30, 2016 and claims priority to TW 106129510 filed on Aug. 30, 2017.

### BACKGROUND OF THE INVENTION

### Field of Invention

The present invention relates to an image sensing method and an image sensor with rolling exposure time compensation; particularly, it relates to such image sensing method and such image sensor with rolling exposure time compensation which adaptively determine an exposure time of at least one sensor row according to a brightness signal of an image.

### Description of Related Art

There are two types of shutters for rolling exposure in conventional image sensors: mechanical shutter and electronics shutter. However, regardless whether a mechanical shutter or electronics shutter is used, due to certain reasons such as the location of the light source, there is a problem of uneven brightness between different rows or columns in an image, causing it hard to correctly identify the image which is for example a fingerprint.

In view of the above, to overcome the drawback in the prior art, the present invention proposes an image sensing method and an image sensor with rolling exposure time compensation, which adaptively determine an exposure time of at least one sensor row according to a brightness signal of an image.

### SUMMARY OF THE INVENTION

From one perspective, the present invention provides an image sensing method with rolling exposure time compensation, comprising: emitting light to an object to generate an image; providing a sensor device having a plurality of sensor units which are arranged by a plurality of columns and a plurality of rows; sensing the image by the sensor device by way of rolling exposure; and adaptively determining an exposure time of at least one row of the sensor device according to an image brightness signal and controlling a rolling shutter according to the exposure time when the sensor device senses the image.

In one preferable embodiment, the step of adaptively determining an exposure time of at least one row of the sensor device according to an image brightness signal includes: in a preparation period, controlling the rolling shutter to sense the image by the sensor device by way of rolling exposure, wherein the at least one row is exposed for a first exposure period which has a predetermined time length, to generate a preparation scan image, and the image brightness signal is generated thereby; and in a compensation period after the preparation period, determining a second exposure period of the at least one row according to the image brightness signal; wherein the exposure time includes the second exposure period.

In the aforementioned embodiment, the step of determining a second exposure period of the at least one row according to the image brightness signal preferably further includes: determining the second exposure period in the compensation period according to a predetermined brightness target.

In the aforementioned embodiment, the image brightness signal is preferably obtained by smoothing an original image brightness signal.

In one preferable embodiment, a light source for emitting the light to the object is located outside and neighboring a first row and/or a last row of the plural rows.

From another perspective, the present invention provides an image sensing method with rolling exposure time compensation, comprising: emitting light to an object to generate an image; providing a sensor device having a plurality of sensor units which are arranged by a plurality of columns and rows; sensing the image by the sensor device by way of rolling exposure; in a preparation period, controlling the rolling shutter to sense the image by the sensor device by way of rolling exposure, wherein at least one row of the sensor device is exposed for a first exposure period which has a predetermined time length, to generate a preparation scan image, and an image brightness signal is generated thereby; and in a compensation period after the preparation period, determining at least one unit exposure time of the at least one row according to the image brightness signal to generate at least one unit scan image, and generating combination image information according to the preparation scan image and the at least one unit scan image.

In one preferable embodiment, the step of determining at least one unit exposure time of the at least one row according to the image brightness signal to generate at least one unit scan image, and generating combination image information according to the preparation scan image and the at least one unit scan image, includes: generating a brightness contour according to the image brightness signal and a bright threshold; and determining the at least one unit exposure time of the at least one row according to the brightness contour, to generate the at least one unit scan image

In one preferable embodiment, the step of determining at least one unit exposure time of the at least one row according to the image brightness signal to generate at least one unit scan image, and generating combination image information according to the preparation scan image and the at least one unit scan image, includes: determining the at least one unit exposure time of the at least one row according to a single row brightness signal of the image brightness signal, to generate the at least one unit scan image.

In one preferable embodiment, a light source for emitting the light to the object is located outside and neighboring a first row and/or a last row of the plural rows.

In one preferable embodiment, the object includes a finger, and the image includes a fingerprint image, and the light source emitting the light to the finger to generate the fingerprint image.

From another perspective, the present invention provides an image sensor with rolling exposure time compensation, for sensing an image, comprising: a sensor device, which includes a plurality of sensor units arranged by a plurality of columns and rows, and is configured to operably sense the image by way of rolling exposure; a light source, which is configured to operably emit light to an object for generating the image; and an exposure time compensation circuit, which is coupled to the sensor device, and is configured to adaptively determine an exposure time of at least one row of the sensor device according to an image brightness signal and control a rolling shutter accordingly when the sensor device senses the image by way of rolling exposure.

In one preferable embodiment, the exposure time compensation circuit controls the rolling shutter such that when the sensor device senses the image by way of rolling exposure in a preparation period, the at least one row is exposed for a first exposure period which has a predetermined time length, whereby the sensor device generates a preparation scan image, and the image brightness signal is generated thereby; and in a compensation period after the preparation period, the exposure time compensation circuit determines a second exposure period of the at least one row according to the image brightness signal, wherein the exposure time includes the second exposure period.

In the aforementioned embodiment, the exposure time compensation circuit preferably determines the second exposure period in the compensation period according to a predetermined brightness target.

In the aforementioned embodiment, the image brightness signal is preferably obtained by smoothing an original image brightness signal.

In one preferable embodiment, the light source for emitting the light to the object is located outside and neighboring a first row and/or a last row of the plural rows.

From another perspective, the present invention provides an image sensor with rolling exposure time compensation, for sensing an image, comprising: a sensor device, which includes a plurality of sensor units arranged by a plurality of columns and rows, and is configured to operably sense the image by way of rolling exposure; a light source, which is configured to operably emit light to an object for generating the image; and an exposure time compensation circuit, which is coupled to the sensor device, and is configured to operably control a rolling shutter, such that when the sensor device senses the image by way of rolling exposure in a preparation period, at least one row of the sensor device is exposed for a first exposure period which has a predetermined time length, whereby the sensor device generates a preparation scan image, and an image brightness signal is generated thereby; and in a compensation period after the preparation period, the exposure time compensation circuit determines at least one unit exposure time of the at least one row according to the image brightness signal, such that the sensor device generates at least one unit scan image, and combination image information is generated according to the preparation scan image and the at least one unit scan image.

In one preferable embodiment, the exposure time compensation circuit generates a brightness contour according to the image brightness signal and a bright threshold, and determines the at least one unit exposure time of the at least one row according to the brightness contour, to generate the at least one unit scan image.

In the aforementioned embodiment, the exposure time compensation circuit preferably determines the at least one unit exposure time of the at least one row according to a single row brightness signal of the image brightness signal, to generate the at least one unit scan image.

In the aforementioned embodiment, the light source for emitting the light to the object is preferably located outside and neighboring a first row and/or a last row of the plural rows.

In one preferable embodiment, the object includes a finger, and the image includes a fingerprint image, and the light source emitting the light to the finger to generate the fingerprint image.

The objectives, technical details, features, and effects of the present invention will be better understood with regard to the detailed description of the embodiments below, with reference to the attached drawings.

### BRIEF DESCRIPTION OF THE DRAWINGS

FIG. 1 is a flowchart showing an image sensing method with rolling exposure time compensation according to the present invention.

FIGS. 2A-2G show a first embodiment of the present invention.

FIGS. 3A-3E show a second embodiment of the present invention.

FIG. 4 shows a third embodiment of the present invention.

### DESCRIPTION OF THE PREFERRED EMBODIMENTS

The drawings as referred to throughout the description of the present invention are for illustration only, to show the interrelations between the circuits and the signal waveforms, but not drawn according to actual scale.

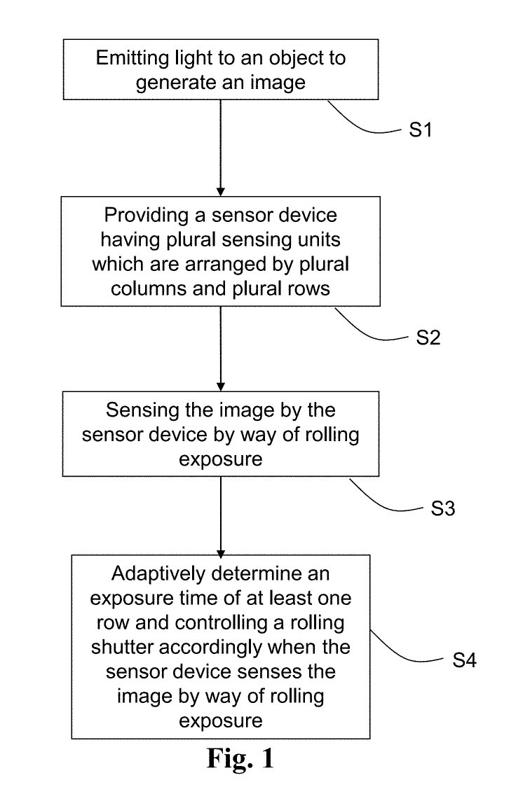

Please refer to FIG. 1, which is a flowchart showing an image sensing method according to an embodiment of the present invention. The flowchart includes steps of: emitting light to an object to generate an image (S1); providing a sensor device having a plurality of sensor units which are arranged by a plurality of columns and a plurality of rows (S2); sensing the image by the sensor device byway of rolling exposure (S3); and adaptively determining an exposure time of at least one row of the sensor device according to an image brightness signal and controlling a rolling shutter according to the exposure time when the sensor device senses the image by way of rolling exposure (S4).

“Rolling exposure” is a method of exposing an image frame row by row, wherein a next row starts scanning after a previous row starts scanning but before this previous row finishes scanning, which is well known to those skilled in this art and therefore is not redundantly explained here. Rolling exposure can be carried out by an electronic shutter or a mechanical shutter. The electronic shutter is used commonly in a complementary metal oxide semiconductor (CMOS) image sensor, wherein the exposure scanning operation is controlled by electronic signals to scan the sensor units in the image sensor row by row from top to bottom (or from bottom to top).

According to the present invention, a light source is provided to emit light to the object for generating the image. For example, the object may be a finger, and the light source is for example but not limited to alight emitting diode (LED) device. When the LED device emits light to the finger, the light scatters, refracts, and reflects according to the fingerprint pattern, whereby a fingerprint image is generated. The method of generating the fingerprint image is known as “light finger”. The sensor device for example may be, but is not limited to, a CMOS image sensor, which has plural CMOS image sensor units arranged by plural columns and plural rows.

As explained, the rolling shutter exposes the CMOS image sensor units of the CMOS image sensor row by row, to receive for example the fingerprint image. However, “row-by-row” does not strictly mean that only one single row is exposed at one time; plural rows can be exposed at the same time. And, for one image frame such as a fingerprint image, it is not limited for the sensor device to scan the fingerprint image only once; the sensor device can scan the fingerprint image multiple times.

According to the present invention, the rolling shutter is controlled to adaptively determine the exposure time of at least one row of the sensor device according to an image brightness signal when the sensor device senses the image by way of rolling exposure. That is, the exposure time of different rows may be different according to the image brightness signal. The image brightness signal will be described in detail later.

The present invention is different from the prior art in at least one aspect that, according to the present invention, the exposure time of different rows maybe adaptively adjusted according to the image brightness signal, such that the overall brightness of an image picture generated according to the present invention can be relatively even between different rows, and the image can be displayed clearer.

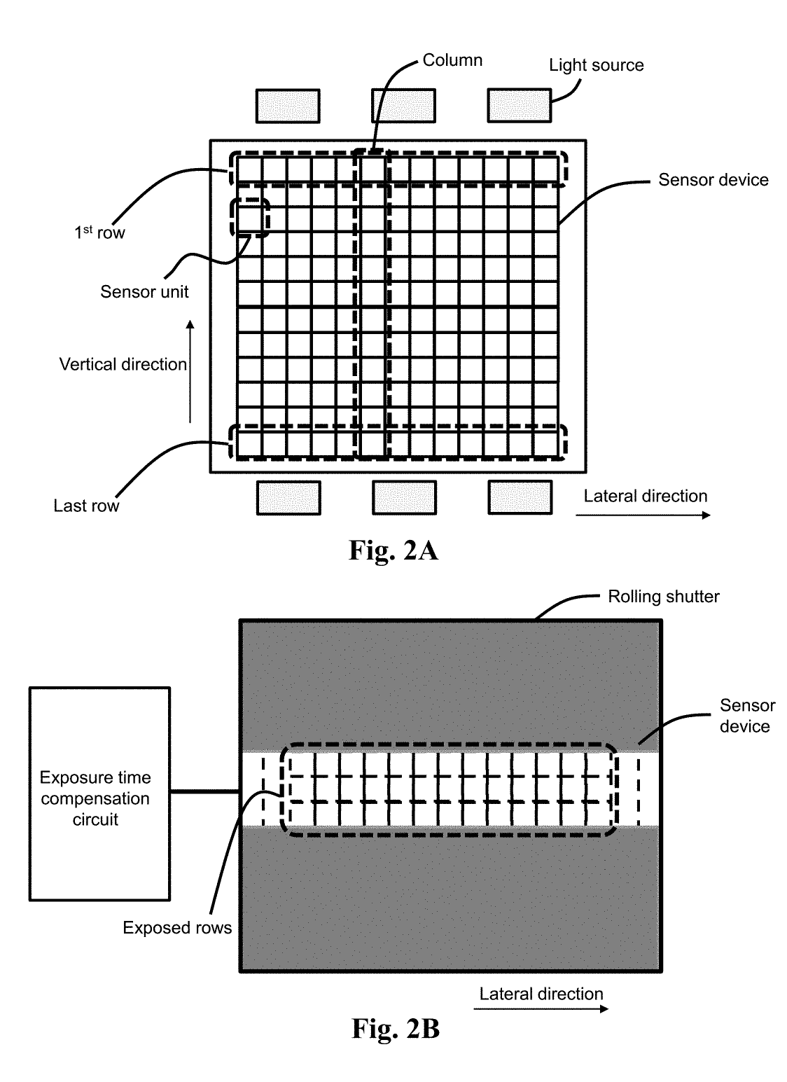

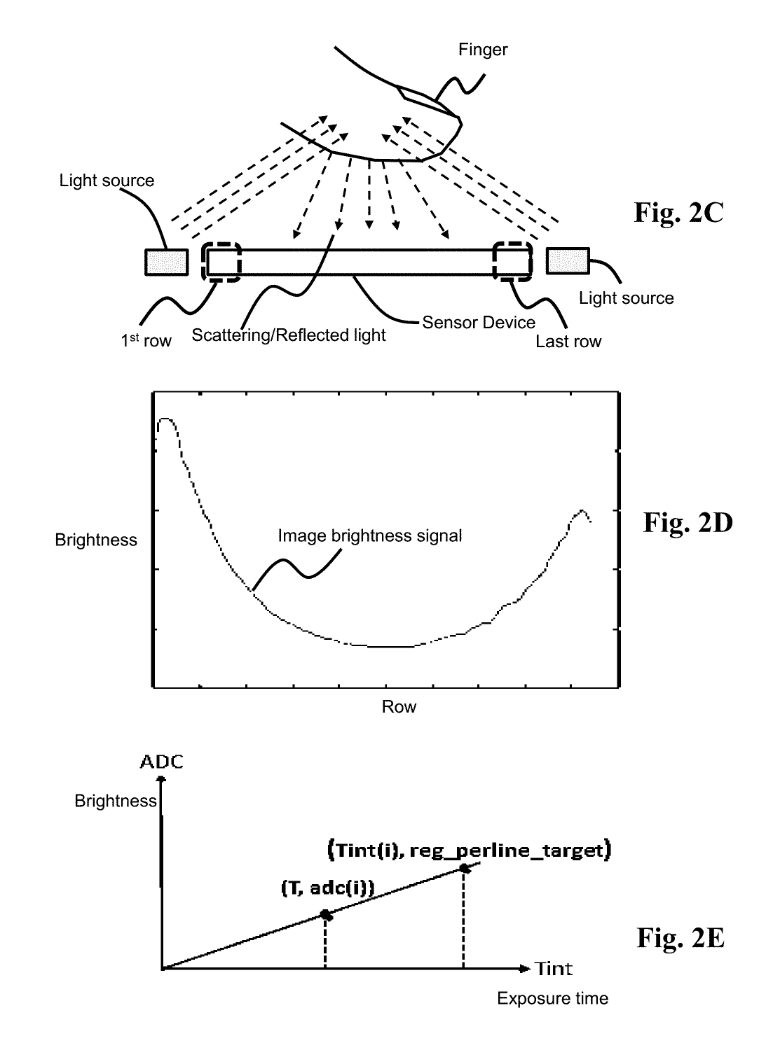

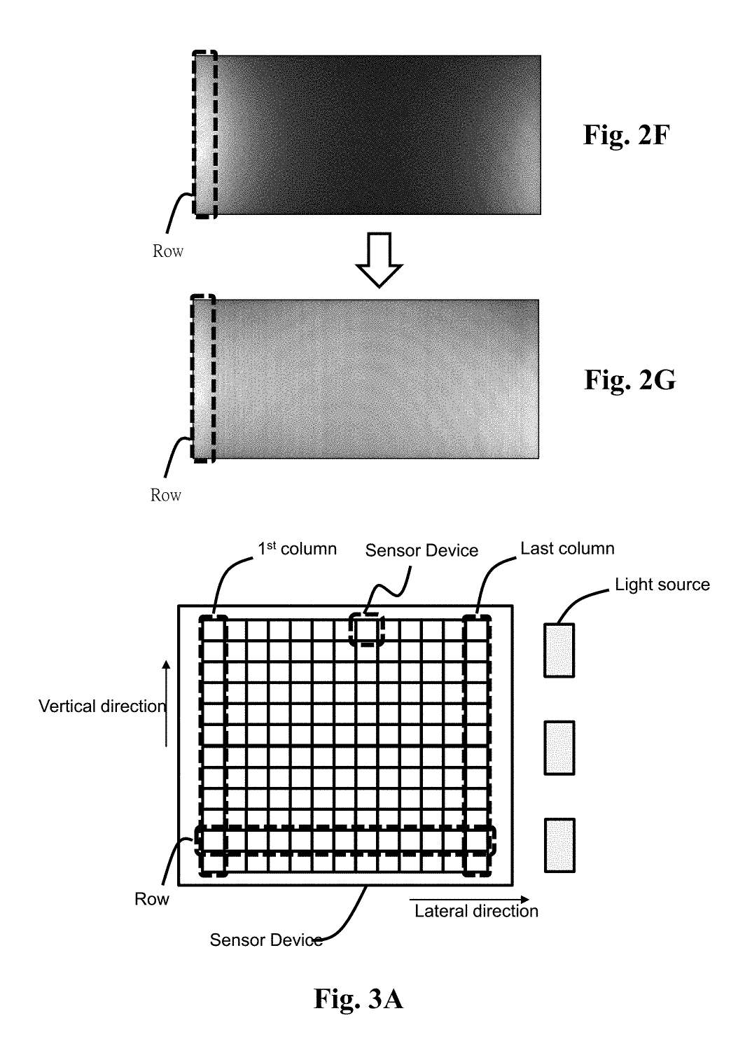

FIGS. 2A-2G show a first embodiment according to the present invention. As shown in FIG. 2A, the sensor device has plural sensor units, which are arranged by plural columns and plural rows, wherein the sensor units of a same row are arranged along a lateral direction, and the sensor units of a same column are arranged along a vertical direction. In this embodiment, light sources for emitting the light to the object are located outside and neighboring a first row and a last row of the plural rows. However, the light sources may be located otherwise, such as outside and neighboring only one of the first row and the last row.

As shown in FIG. 2B, an exposure time compensation circuit is coupled to the sensor device. The exposure time compensation circuit adaptively determines an exposure time of at least one row of the sensor device according to an image brightness signal (as indicated by translucent regions shown in the figure) and controls a rolling shutter according to the exposure time when the sensor device senses the image by way of rolling exposure. The “exposure time of at least one row” refers to one or more rows which is/are being exposed to receive the image during the rolling exposure, as shown in the figure.

In the embodiment show in FIG. 2C, the light sources for emitting the light to the object are located outside and neighboring a first row and a last row of the plural rows. As described earlier, the light sources emit light to the finger, and the light scatters, refracts, and reflects according to the fingerprint pattern of the finger to generate the fingerprint image. The method of generating the fingerprint image is known as “light finger”. The sensor device senses the fingerprint image. In FIG. 2C, for illustration purpose, the finger is not in direct contact to the sensor device; in implementation, the finger can be in direct contact or not in direct contact to the sensor device, with or without a transparent material between the finger and the sensor device.

In one embodiment, the exposure time compensation circuit controls the rolling shutter, such that when the sensor device senses the image by way of rolling exposure in a preparation period, the at least one row is exposed for a first exposure period which has a predetermined time length, whereby the sensor device generates a preparation scan image, and the image brightness signal is generated according to the preparation scan image; and in a compensation period after the preparation period, the exposure time compensation circuit determines a second exposure period of the at least one row according to the image brightness signal, wherein the exposure time includes the second exposure period.

FIG. 2D shows that in this embodiment, the exposure time compensation circuit controls the rolling shutter, such that when the sensor device senses the image byway of rolling exposure in a preparation period, the every row in the sensor device is exposed for the first exposure period which has a predetermined time length, whereby the sensor device generates the preparation scan image, and the image brightness signal as shown in FIG. 2D is generated according to the preparation scan image. The predetermined time length is for example but not limited to a fixed time period, i.e., every row in the sensor device is exposed for the same time in a first scan. Next, in one embodiment, an original image brightness signal is generated by the sensor device in the first scan. Next, the image brightness signal is obtained by smoothing the original image brightness signal. As shown in FIG. 2D, in this embodiment, a first row and a last row which are close to the light sources have relatively higher image brightness, and rows which are relatively farther away from the light source have relatively lower image brightness. Higher image brightness indicates that the row is brighter, and lower image brightness indicates that the row is darker.

FIG. 2E shows correlation between the image brightness signal ADC and the exposure time Tint. FIG. 2E also shows a heterodyne method of determining the second exposure period of the at least one row. Exposure time Tint of a row is substantially proportional to the image brightness signal ADC. Assuming that a row i has a first exposure period T and an image brightness signal adc(i) in the preparation period, then, in this embodiment, a predetermined brightness target reg perline target of the image brightness is divided by the image brightness signal adc(i) and multiplied by time T to obtain a second exposure period Tint(i)=(ref_perline_target/adc(i))*T.

FIGS. 2F and 2G show pictures of the preparation scan image which is generated in the preparation period, and a compensated scan image which is generated in the compensation period after the preparation period, respectively. FIGS. 2F and 2G show that, according to the present invention, by adaptively determining the exposure time of the sensor rows according to the brightness signal of the preparation scan image, the compensated scan image is a clear fingerprint image. On the other hand, the prior art image picture of the fingerprint is not compensated, and is same as the preparation scan image shown in FIG. 2G, which is not clear. In the prior art, the brightness of the image picture of the fingerprint is not uniform, and the fingerprint image is not clear. The present invention is advantageous over the prior art in that the overall brightness of an image picture generated according to the present invention is relatively more uniform between different rows, and the image is clearer.

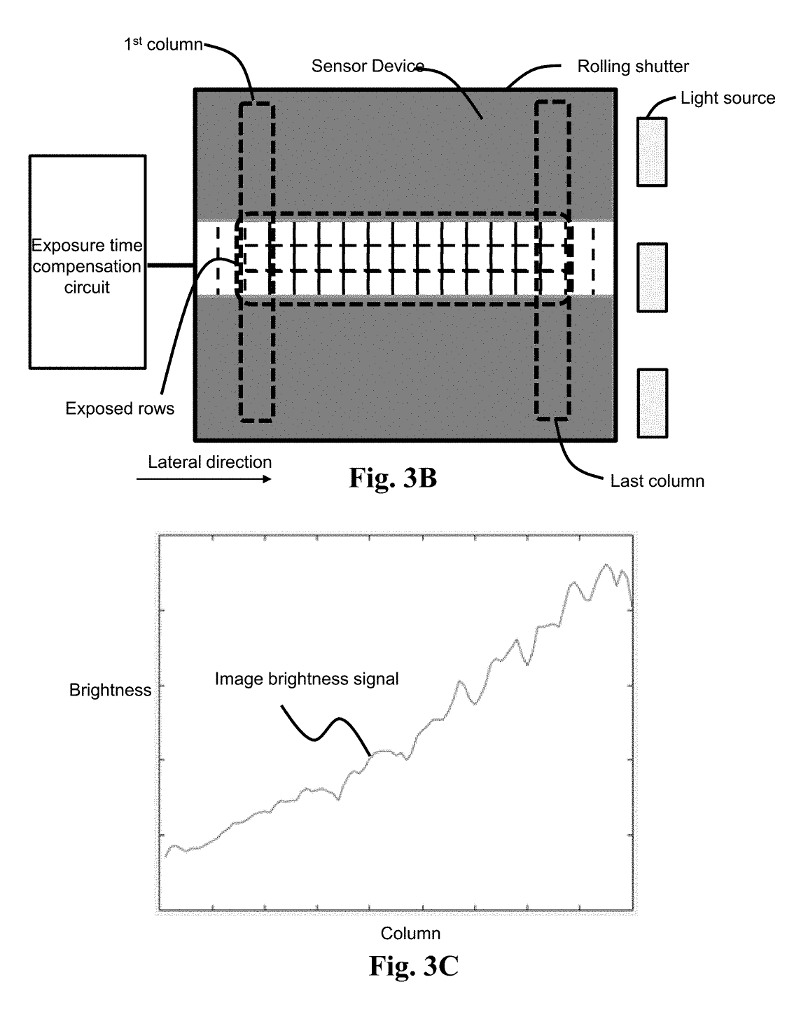

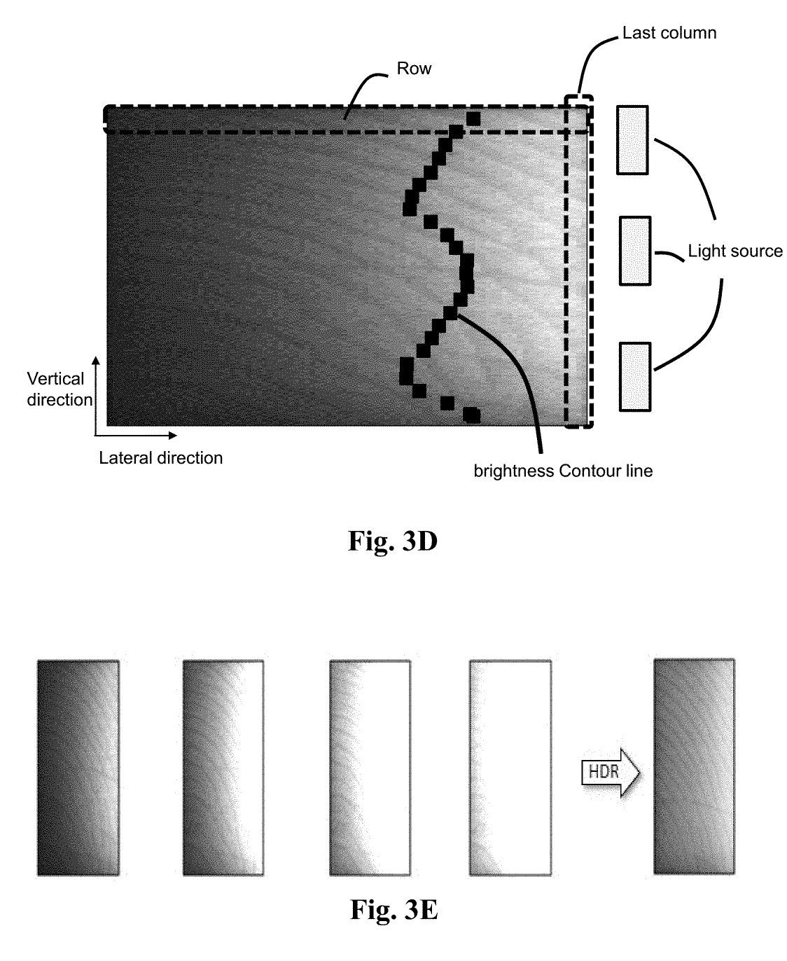

FIGS. 3A-3F show a second embodiment of the present invention. This embodiment is different from the first embodiment in that, as shown in FIG. 3A, the light sources are located outside and neighboring the last “column” of the plural columns. Certainly, in other embodiments, the light sources may be located outside and neighboring the first column and the last column, or only the first column.

As shown in FIG. 3B, in this embodiment, the exposure time compensation circuit controls the rolling shutter such that when the sensor device senses the image byway of rolling exposure in a preparation period, at least one row is exposed for a predetermined time length, whereby the sensor device generates a preparation scan image, and the image brightness signal is generated thereby.

FIG. 3C shows the image brightness signal generated in the preparation period of this embodiment. As shown in FIG. 3C, in this embodiment, the exposure time compensation circuit controls the rolling shutter, such that when the sensor device senses the image by way of rolling exposure in a preparation period, every row in the sensor device is exposed for the predetermined time length, whereby the sensor device generates the preparation scan image, and the image brightness signal is generated according to the preparation scan image. The predetermined time length is for example but not limited to a fixed time period, i.e., every row in the sensor device is exposed for the same time in a first scan. Next, in this embodiment, an original image brightness signal is generated by the sensor device in the first scan. Next, an image brightness signal is obtained by smoothing the original image brightness signal. As shown in FIG. 3C, in this embodiment, the last column which is close to the light sources has relatively higher image brightness, and columns (close to the first column) which are relatively farther away from the light source have relatively lower image brightness. Higher image brightness indicates that the column is brighter, and lower image brightness indicates that the column is darker.

FIG. 3D shows a picture of the preparation scan image which is generated in the preparation period of this embodiment. In this embodiment, in the compensation period after the preparation period, the exposure time compensation circuit determines at least one unit exposure time of the at least one row according to the image brightness signal shown in FIG. 3C, whereby the sensor device generates at least one unit scan image, and combination image information is generated according to the preparation scan image and the at least one unit scan image.

More specifically, in this embodiment, the light sources are located outside and neighboring the last column of the plural columns, and the rolling shutter exposes the rows sequentially (row-by-row or rows-by-rows), so the scanning direction and the brightness distribution (increasing along the lateral direction) are different. Therefore, the rolling exposure time compensation method according to the first embodiment, i.e., adaptively adjusting exposure time of the rows, still needs to face an issue that the brightness is not uniform along the lateral direction. In this second embodiment, the image brightness signal is compared with a bright threshold, to generate a brightness contour. For example, the brightness contour may be formed by a group of contour points, and the points are obtained by the following steps: first, comparing the brightness of each sensor unit of each row with a brightness threshold along the lateral direction; second, in each row, determining a last sensor unit whose brightness is not higher (or higher, or a first sensor unit whose brightness is not lower) than the brightness threshold as a contour point of the group; and third, forming the contour by the contour points.

Next, for example, the highest brightness among the sensor units of the image brightness signal is selected as a brightness target in the preparation period, for example but not limited to a brightness of a sensor unit of the last column which is located nearest to the light source. Next, in this embodiment, the unit exposure time of each row is individually determined by for example the aforementioned heterodyne method, according to the brightness target and a contour point in that row, wherein different rows may have different unit exposure times. Next, in the compensation period, the unit scan image is generated with rolling exposure time compensation, wherein the exposure time of each row is the individually calculated unit exposure time. Next, at least one unit scan image is generated (in one embodiment, plural unit scan images are generated by repeating the aforementioned steps of generating the brightness contour and the unit scan image, until the brightness of every the sensor unit achieves the brightness target in at least one unit scan image). Next, by high dynamic range imaging (HDR) method, combination image information is generated by combining the preparation scan image and the at least one unit scan image. The HDR method is well known to those skilled in this art and therefore is not redundantly explained here.

As shown in FIG. 3E, in this embodiment, each of the four pictures at the left side of the “HDR” arrow corresponds to one unit scan image. The combination image information generated by the HDR method is shown at the right side of the “HDR” arrow. Comparing to the picture which is not compensated with rolling exposure time compensation, a clearer fingerprint image is obtained according to the present invention.

The exposure time compensation circuit determines at least one unit exposure time of the at least one row according to the image brightness signal, whereby the sensor device generates at least one unit scan image, and the combination image information is generated according to the preparation scan image and the at least one unit scan image.

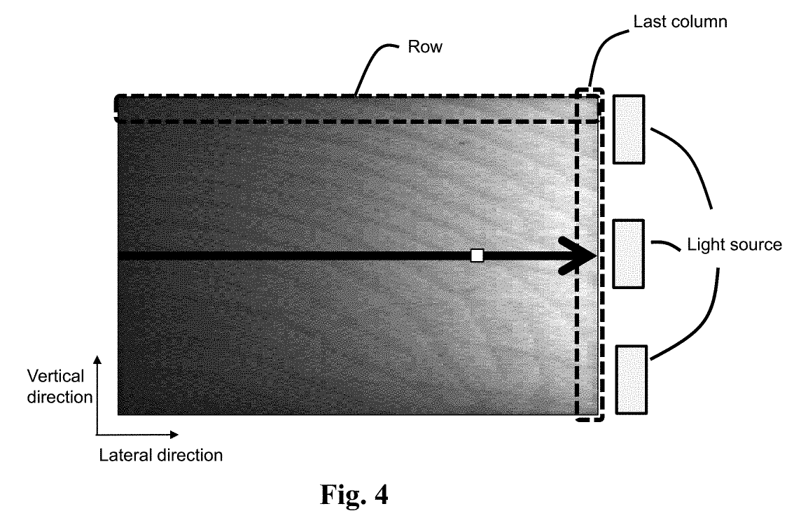

FIG. 4 shows a third embodiment of the present invention. As shown in the figure, this embodiment is different from the second embodiment in that, in this embodiment, the exposure time compensation circuit determines at least one unit exposure time of at least one row according to the brightness signal of one single row in the image brightness signal, to generate the at least one unit scan image. In this embodiment, for saving calculation time, only one row (for example but not limited to a middle row) is selected to obtain the single row brightness signal, instead of comparing the image brightness signal of all sensor units with the brightness threshold to obtain the brightness contour of the whole image. In this embodiment, the light source is located outside the last column, so the brightness increases along the lateral direction; in this case, although only one row is selected (instead of all rows), the variation in this selected row can represent the brightness change from column to column in all the rows. The brightness of each sensor unit in the selected row is compared with a brightness threshold along the lateral direction, and a last sensor unit whose brightness is not higher (or higher, or a first sensor unit whose brightness is not lower) than the brightness threshold of this selected row is determined as a boundary point, whose brightness is determined as the boundary brightness.

Next, for example, the highest brightness in the single row is selected as a brightness target in the preparation period, for example but not limited to a brightness of a sensor unit of the last column of the signal row which is located nearest to the light source. Next, the unit exposure time of each row is determined by for example the aforementioned heterodyne method, according to the brightness target and the boundary brightness. Next, at least one of the unit scan image is generated (in one embodiment, plural unit scan images are generated by repeating the aforementioned steps of generating the brightness contour and the unit scan image, until the brightness of every the sensor unit achieves the brightness target in at least one unit scan image). Next, by high dynamic range imaging (HDR) method, combination image information is generated by combining the preparation scan image and the at least one unit scan image.

The present invention has been described in considerable detail with reference to certain preferred embodiments thereof. It should be understood that the description is for illustrative purpose, not for limiting the scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. It is not limited for each of the embodiments described hereinbefore to be used alone; under the spirit of the present invention, two or more of the embodiments described hereinbefore can be used in combination. For example, two or more of the embodiments can be used together, or, a part of one embodiment can be used to replace a corresponding part of another embodiment. In view of the foregoing, the spirit of the present invention should cover both such and other modifications and variations, which should be interpreted to fall within the scope of the following claims and their equivalents.

What is claimed is:

1. An image sensing method with rolling exposure time compensation, comprising:
emitting light to an object to generate an image;
providing a sensor device having a plurality of sensor units which are arranged by a plurality of columns and a plurality of rows;
sensing the image by the sensor device by way of rolling exposure; and
adaptively determining an exposure time of at least one row of the sensor device according to an image brightness signal and controlling a rolling shutter according to the exposure time when the sensor device senses the image.

2. The image sensing method of claim 1, wherein the step of adaptively determining an exposure time of at least one row of the sensor device according to an image brightness signal includes:
in a preparation period, controlling the rolling shutter to sense the image by the sensor device by way of rolling exposure, wherein the at least one row is exposed for a first exposure period which has a predetermined time length, to generate a preparation scan image, and the image brightness signal is generated thereby; and
in a compensation period after the preparation period, determining a second exposure period of the at least one row according to the image brightness signal;
wherein the exposure time includes the second exposure period.

3. The image sensing method of claim 2, wherein the step of determining a second exposure period of the at least one row according to the image brightness signal further includes: determining the second exposure period in the compensation period according to a predetermined brightness target.

4. The image sensing method of claim 3, wherein the image brightness signal is obtained by smoothing an original image brightness signal.

5. The image sensing method of claim 1, wherein a light source for emitting the light to the object is located outside and neighboring a first row and/or a last row of the plurality of rows.

6. The image sensing method of claim 1, wherein the object includes a finger, and the image includes a fingerprint image, and the light source emitting the light to the finger to generate the fingerprint image.

7. An image sensing method with rolling exposure time compensation, comprising:
emitting light to an object to generate an image;
providing a sensor device having a plurality of sensor units which are arranged by a plurality of columns and a plurality of rows;
sensing the image by the sensor device by way of rolling exposure;
in a preparation period, controlling the rolling shutter to sense the image by the sensor device by way of rolling exposure, wherein at least one row of the sensor device is exposed for a first exposure period which has a predetermined time length, to generate a preparation scan image, and an image brightness signal is generated thereby; and
in a compensation period after the preparation period, determining at least one unit exposure time of the at least one row according to the image brightness signal to generate at least one unit scan image, and generating combination image information according to the preparation scan image and the at least one unit scan image.

8. The image sensing method of claim 7, wherein the step of determining at least one unit exposure time of the at least one row according to the image brightness signal to generate at least one unit scan image, and generating combination image information according to the preparation scan image and the at least one unit scan image, includes:
generating a brightness contour according to the image brightness signal and a bright threshold; and
determining the at least one unit exposure time of the at least one row according to the brightness contour, to generate the at least one unit scan image.

9. The image sensing method of claim 7, wherein the step of determining at least one unit exposure time of the at least one row according to the image brightness signal to generate at least one unit scan image, and generating combination image information according to the preparation scan image and the at least one unit scan image, includes: determining the at least one unit exposure time of the at least one row according to a single row brightness signal of the image brightness signal, to generate the at least one unit scan image.

10. The image sensing method of claim 7, wherein a light source for emitting the light to the object is located outside and neighboring a first row and/or a last row of the plurality of rows.

11. The image sensing method of claim 7, wherein the object includes a finger, and the image includes a fingerprint image, and the light source emitting the light to the finger to generate the fingerprint image.

12. An image sensor with rolling exposure time compensation, for sensing an image, comprising:
a sensor device, which includes a plurality of sensor units arranged by a plurality of columns and a plurality of rows, and is configured to operably sense the image byway of rolling exposure;
alight source, which is configured to operably emit light to an object for generating the image; and
an exposure time compensation circuit, which is coupled to the sensor device, and is configured to adaptively determine an exposure time of at least one row of the sensor device according to an image brightness signal and control a rolling shutter accordingly when the sensor device senses the image by way of rolling exposure.

13. The image sensor of claim 12, wherein the exposure time compensation circuit controls the rolling shutter such that when the sensor device senses the image by way of rolling exposure in a preparation period, the at least one row is exposed for a first exposure period which has a predetermined time length, whereby the sensor device generates a preparation scan image, and the image brightness signal is generated thereby; and in a compensation period after the preparation period, the exposure time compensation circuit determines a second exposure period of the at least one row according to the image brightness signal, wherein the exposure time includes the second exposure period.

14. The image sensor of claim 13, wherein the exposure time compensation circuit determines the second exposure period in the compensation period according to a predetermined brightness target.

15. The image sensor of claim 14, wherein the image brightness signal is obtained by smoothing an original image brightness signal.

16. The image sensor of claim 12, wherein the light source for emitting the light to the object is located outside and neighboring a first row and/or a last row of the plural rows.

17. The image sensor of claim 12, wherein the object includes a finger, and the image includes a fingerprint image, and the light source emitting the light to the finger to generate the fingerprint image.

18. An image sensor with rolling exposure time compensation, for sensing an image, comprising:
a sensor device, which includes a plurality of sensor units arranged by a plurality of columns and a plurality of rows, and is configured to operably sense the image by way of rolling exposure;
a light source, which is configured to operably emit light to an object for generating the image; and
an exposure time compensation circuit, which is coupled to the sensor device, and is configured to operably control a rolling shutter, such that when the sensor device senses the image by way of rolling exposure in a preparation period, at least one row of the sensor device is exposed for a first exposure period which has a predetermined time length, whereby the sensor device generates a preparation scan image, and an image brightness signal is generated thereby; and in a compensation period after the preparation period, the exposure time compensation circuit determines at least one unit exposure time of the at least one row according to the image brightness signal, such that the sensor device generates at least one unit scan image, and combination image information is generated according to the preparation scan image and the at least one unit scan image.

19. The image sensor of claim 18, wherein the exposure time compensation circuit generates a brightness contour according to the image brightness signal and a bright threshold, and determines the at least one unit exposure time of the at least one row according to the brightness contour, to generate the at least one unit scan image.

20. The image sensor of claim 18, wherein the exposure time compensation circuit determines the at least one unit exposure time of the at least one row according to a single row brightness signal of the image brightness signal, to generate the at least one unit scan image.

21. The image sensor of claim 18, wherein the light source for emitting the light to the object is located outside and neighboring a first row and/or a last row of the plural rows.

22. The image sensor of claim 18, wherein the object includes a finger, and the image includes a fingerprint image, and the light source emitting the light to the finger to generate the fingerprint image.
